(19) United States
(12) Patent Application Publication
(10) Pub. No.: US 2005/0165742 A1
(43) Pub. Date: Jul. 28, 2005

(54) Searching previously viewed web sites

(76) Inventor: Weisheke Chin, Vienna, VA (US)

Correspondence Address: FISH & RICHARDSON P.C., P.O. BOX 1022, MINNEAPOLIS, MN, 55440-1022, US

(21) Appl. No.: 10/747,653

(22) Filed: Dec. 30, 2003

(51) Int. Cl. G06F 7/00

(52) U.S. Cl. 707/3

(57) ABSTRACT

A computer-implemented method of searching for particular data includes receiving a query from a user for particular online data content, searching for the particular online data content at least within data content locations that have been previously accessed by the user, presenting to the user search results satisfying the query. In the presentation of the search results search results corresponding to data content locations that have been accessed previously by the user are distinguished from search results corresponding to data content location that have not been accessed previously by the user.

### TECHNICAL FIELD

This disclosure relates to performing a search for electronic data.

### BACKGROUND

With the explosion of information on the Internet, it has become increasingly difficult to conduct a search for information on the Internet that returns results in a manner and a format that are useful to the person conducting the search. Frequently, when a search is performed, the most useful and relevant results are scattered and buried among thousands of results.

In other instances, when a search is performed for information on the Internet, a search may yield few or no results even though relevant results exist on the Internet. Few or no results may occur because the Internet sites and the web pages within Internet sites that contain the desired results may not be reachable by the search tool or because the search query is overly narrow.

### SUMMARY

In a first general aspect, a computer-implemented method of searching for particular data includes receiving a query from a user for particular online data content, searching for the particular online data content at least within data content locations that have been previously accessed by the user, and presenting to the user search results satisfying the query. In the presentation of the search results, search results corresponding to data content locations that have been accessed previously by the user are distinguished from search results corresponding to data content location that have not been accessed previously by the user.

The method of searching for particular data can include one or more of the following features. For example, only search results corresponding to data content locations that have been accessed previously by the user can be presented to the user. Search results corresponding to data content locations that have been accessed previously by the user can be distinguished from search results corresponding to data content location that have not been accessed previously by the user by the order in which the search results are presented to the user. Search results corresponding to data content locations that have been accessed previously by the user can be distinguished from search results corresponding to data content location that have not been accessed previously by the user by the visual presentation of the individual search results. Search results corresponding to data content locations that have been accessed previously by the user can be presented to the user in a font that is different from a font in which search results corresponding to data content locations that have not been accessed previously by the user are presented to the user. In the presentation of the search results, search results corresponding to data content locations that have been previously accessed by the user within a predetermined time period can be distinguished from search results that have not been previously accessed by the user. The predetermined time period can be a period that ends at the time the search query was received from the user or at a time before the search query was received from the user. The time period can be specified by the user.

Furthermore, the method can include storing the identities of data content locations that have been previously accessed by the user. The identities can be stored on a host computer system that communicates with a client computer system used by the user. A list of the identities of data content locations that have been previously accessed by the user can be received from a client computer system used by the user. The method can further include storing data content from data content locations that have been previously accessed by the user. Stored data content can be stored on a host computer system that communicates with a client computer system used by the user. The particular online data content can be sought within data content that is stored on the host computer.

These general and specific aspects may be implemented using a system, a method, or a computer program, or any combination of systems, methods, and computer programs.

Other features and advantages will be apparent from the description and drawings, and from the claims.

### DESCRIPTION OF DRAWINGS

FIG. 1 shows elements of a graphical user interface for an exemplary search application.

FIG. 2A is a block diagram of a communications system.

FIG. 2B is an expansion of the block diagram of FIG. 2A.

FIGS. 3A-3C show elements of a graphical user interface for an exemplary browser application.

FIG. 4 is a flow chart of a process for searching for data content.

FIG. 5 is a flow chart of a process for searching for data content.

FIG. 6 is a flow chart of a process for locating and displaying data content.

Like reference symbols in the various drawings indicate like elements.

### DETAILED DESCRIPTION

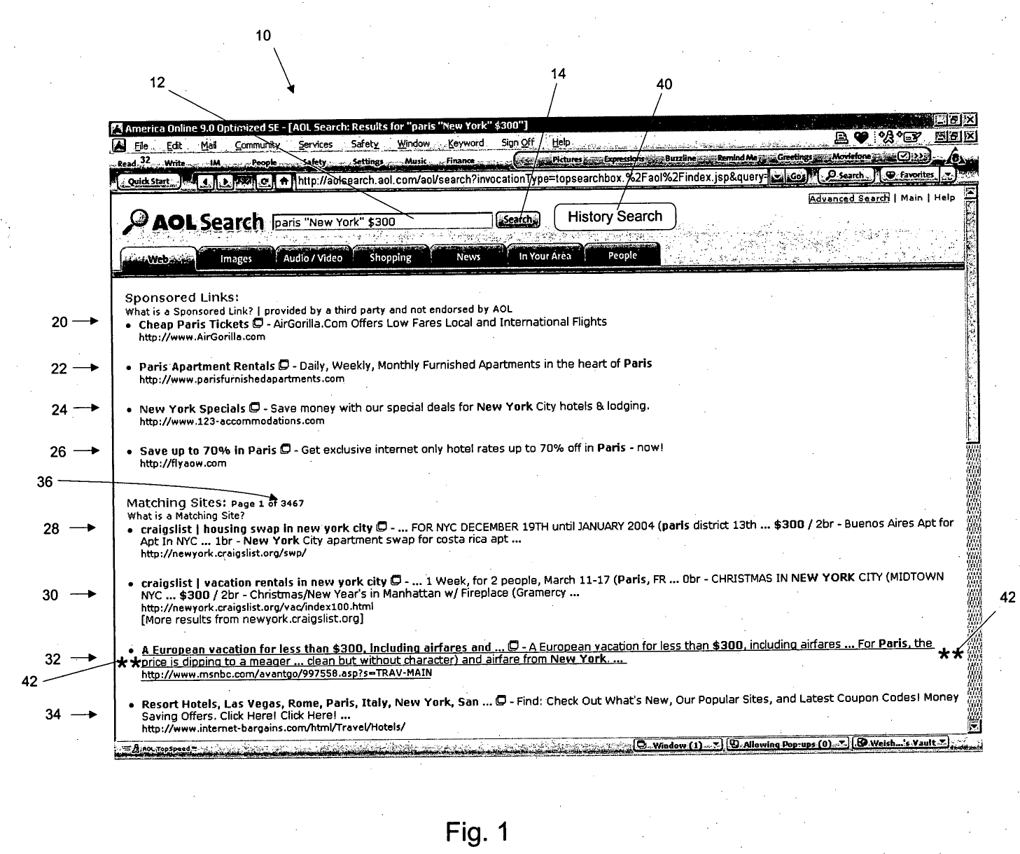

FIG. 1 shows a graphical user interface (“GUI”) 10 to an computer-implemented application that is used to search for online data content. The application allows a user to search for data content, for example, among data content on the Internet, and to limit the results of the search to data content that the user has previously accessed. The GUI 10 includes a search field 12 in which a user can enter one or more search terms to specify desired data content. For example, in the exemplary GUI 10 when the user wants to find data content that includes information about a $300 airfare from New York to Paris, the terms “Paris,” “New York” and “$300” are entered in search field 12. The GUI 10 includes a “search” command button 14 that a user can click or otherwise select to initiate a search for the desired data content among all Internet resources available to the search application. The results of the search are displayed as paragraphs 20, 22, 24, 26, 28, 30, 32, 34 that correspond to different online resources (e.g., websites) where the search terms are found and which may contain a short description of the data content that can be found by linking to the online resource. A counter 36 indicates the total number of online resources that are found that satisfy the search query.

The GUI 10 also includes a “history search” command button 40 that a user can click or otherwise select to initiate a search for the desired data content only within the online resources that the user has previously accessed or viewed. Thus, for example, if the user has previously navigated to an online resource containing the desired data content but has forgotten the location of that resource, the history search can be used to limit the search for the desired data to those resources that the user has previously accessed. This reduces the number of extraneous search results.

The application may track the online resources accessed by a user, so that when the user initiates a search by clicking on the history search command button 40, the search is performed only within those online resources that the user has previously accessed. Alternatively, clicking the history search command button 40 can highlight particular paragraphs 22, 34 from a general search where the particular paragraphs correspond to online resources that the user has previously viewed. Highlighting of the particular paragraphs 22, 34 can be achieved by displaying the search results in a distinctive font, underlining of the text, adding highlight marks 42 to the particular paragraphs, and/or placing the particular paragraphs at the top of the search result list. Still further, clicking the history search button 40 may cull search results from a general search results, such that only results from previously-accessed online resources are displayed to the user.

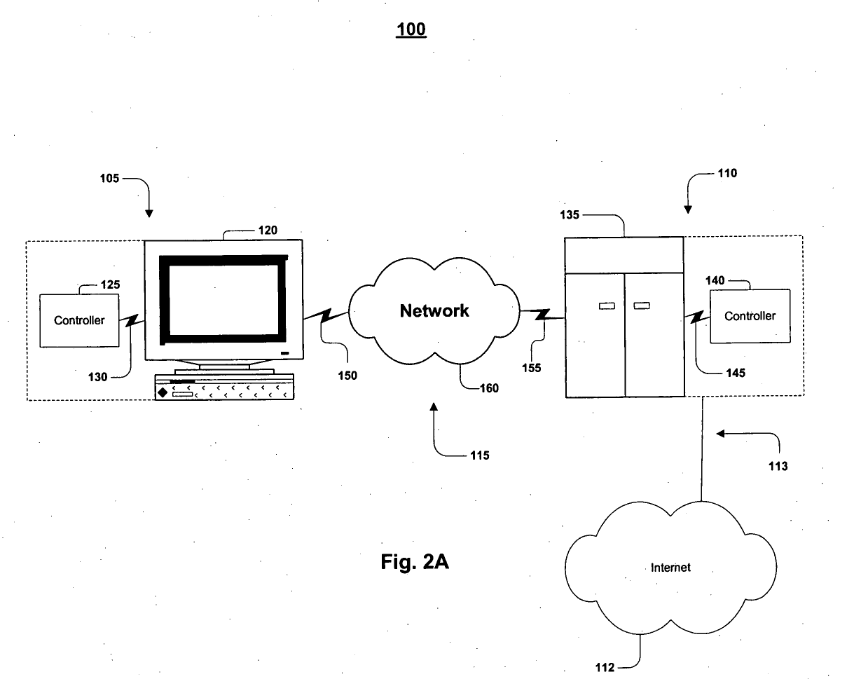

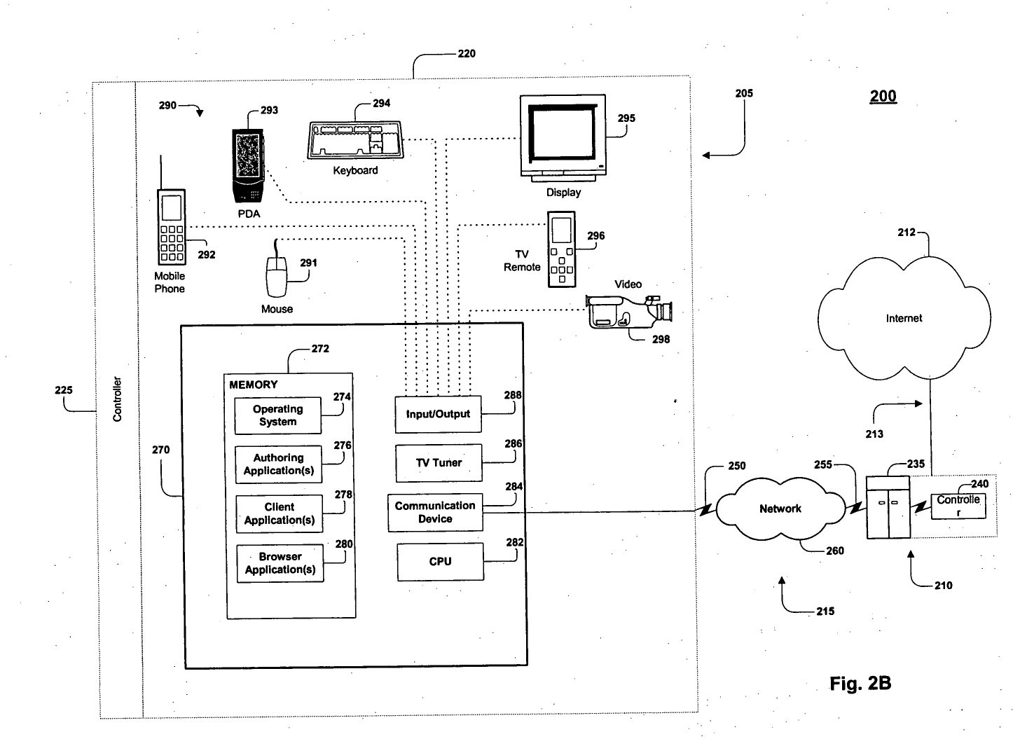

For illustrative purposes, FIGS. 2A and 2B describe a communications system that implements techniques for searching for electronic data content. For brevity, several elements in the figures described below are represented as monolithic entities. However, as would be understood by one skilled in the art, these elements each may include numerous interconnected computers and components designed to perform a set of specified operations.

Referring to FIG. 2A, a communications system 100 is capable of delivering and exchanging data between a local personal computing system 105 (hereinafter “local system 105”) and a remote computing system 110 (hereinafter “remote system 110” through a communications link 115. The local personal computing system 105 typically includes one or more personal computing devices 120 and/or personal computing controllers 125, and the remote computing system 110 typically includes one or more remote computing devices 135 and/or remote computing controllers 140. For example, the local personal computing system 105 or the remote computing system 110 may include one or more general-purpose computers (e.g., personal computers), one or more special-purpose computers (e.g., devices specifically programmed to communicate with each other and/or the local personal computing system 105 or the remote system 110), or a combination of one or more general-purpose computers and one or more special-purpose computers. The local personal computing system 105 and the remote computing system 110 may be arranged to operate within or in concert with one or more other systems, such as, for example, one or more LANs (“Local Area Networks”) and/or one or more WANs (“Wide Area Networks”).

The personal computing device 120 (or the remote computing device 135) is generally capable of executing instructions under the command of a personal computing controller 125 (or a remote computing controller 140). The personal computing device 120 (or the remote computing device 135) is connected to the personal computing controller 125 (or the remote computing controller 140) by a wired or wireless data pathway 130 (or pathway 145) capable of delivering data.

The personal computing device 120, the personal computing controller 125, the remote computing device 135, and the remote computing controller 140 each typically include one or more hardware components and/or software components. A local system may include a personal computing device, such as, for example, a personal computer (e.g., a laptop computer, a notebook computer, or a desktop computer), a workstation, and a personal digital assistant (PDA) that may have access to a local storage device, such as, for example, a hard drive, a zip drive, a digital video disk (DVD), a compact disk (CD), a floppy disk, and a local file server acting as a local storage device, and may communicate and share resources (e.g., a local file server or a local library) with other personal computing devices through a network (e.g., a LAN). A remote system 110 may include devices (e.g., a workstation, a server, a caching device) capable of being accessed by the local device through a non-local delivery network, such as, for example, a WAN or the Internet, or that are accessible through a service provider, such as, for example, an Application Service Provider (ASP) or a data store accessed through or maintained by an Internet Service Provider (ISP), or through a caching device of an ASP or an ISP. The personal computing device 120 may include a client device and the remote computing device 135 may include a host device.

The electronic data content stored on the local and/or remote devices may include text files, documents, audio files, video files, e-mail files, directories, sub-directories, cached temporary files (e.g., web pages), downloaded files, data files, links to and/or metadata for electronic assets (e.g., files, web pages) or other types of content capable of being stored on the device. In addition, the electronic data content stored on the remote device 135 also may include data content from data content locations such as, for example, an Internet site.

An example of the personal computing controller 125 or the remote computing controller 140 is a software application loaded on the personal computing device 120 or the remote computing device 135 for commanding and directing communications enabled by the personal computing device 120 or the remote computing device 135. Other examples include a program, a piece of code, an instruction, a device, a computer, a computer system, or a combination thereof, for independently or collectively instructing the personal computing device 120 or the remote computing device 135 to interact and operate as described. The personal computing controller 125 and the remote computing controller 140 may be embodied permanently or temporarily in any type of machine, component, physical or virtual equipment, storage medium, or propagated signal capable of providing instructions to the personal computing device 120 or the remote computing device 135. The personal computing controller 125 may include a client controller and the remote computing controller 140 may include a host controller.

The communications link 115 typically includes a delivery network 160 capable of enabling direct or indirect communication between the local personal computing system 105 and the remote computing system 110, irrespective of physical separation. Examples of a delivery network 160 include the Internet, the World Wide Web, WANs, LANs, analog or digital wired and wireless telephone networks (e.g., Public Switched Telephone Network (PSTN), Integrated Services Digital Network (ISDN), and Digital Subscriber Line (xDSL)), radio, television, cable, satellite, and/or any other delivery or tunneling mechanism for carrying data. The communications link 115 may include communication pathways 150, 155 that enable communications through the one or more delivery networks 160 described above. Each of the communication pathways 150, 155 may include, for example, a wired, wireless, cable or satellite communication pathway.

The remote system 110 can be connected to and can access data content within the Internet 112 through a communications link 113 that is similar to communications link 115. Thus, the local system 105 can request the remote system 110 to provide data content from the Internet 112. The remote system 110 can fetch the requested data content from the Internet 112 and provide the content to the local system 105 through the communications link 115.

As shown in FIG. 2A, a user of a computer system can access electronic content or other resources either stored locally at the user's own local system 105 (e.g., a personal or laptop computer) or remotely at one or more remote server systems 110 or from the Internet 112. An example of a server system is a host computer that provides subscribers with online computer services such as e-mail, chat rooms, Internet access, electronic newspapers and magazines, etc. Users of a host computer's online services typically communicate with one or more central server systems through client software executing on their respective local systems. In practice, a remote server system 110 typically will not be a single monolithic entity but rather will be a network of interconnected server computers, possibly physically dispersed from each other, each dedicated to its own set of duties.

FIG. 2B illustrates a communication system 200 that includes a local personal computing system 205 communicating with a remote computing system 210 through a communications link 215. Local personal computing system 205 typically includes one or more personal computing devices 220 and one or more personal computing controllers 225 for controlling the personal computing devices 220. Remote computing system 210 typically includes one or more remote computing devices 235 and one or more remote computing controllers 240 for controlling the remote computing devices 235. The communications link 215 may include communication pathways 250, 255 enabling communications through the one or more delivery networks 260. Remote system 210 is also connected to the Internet 212 through a communications link 213.

Examples of each element within the communication system 200 of FIG. 2B are broadly described above with respect to FIG. 2A. In particular, the remote computing system 210 and the communications link 215 typically have attributes comparable to those described with respect to the remote computing system 110 and the communications link 115 of FIG. 2A, respectively. Likewise, the local personal computing system 205 of FIG. 2B typically has attributes comparable to and may illustrate one possible implementation of the local personal computing system 105 of FIG. 2A.

The personal computing device 220 typically includes a general purpose computer 270 having an internal or external memory or storage 272 for storing data and programs such as an operating system (OS) 274 (e.g., Disk Operating System (DOS), Windows™, Windows 95™, Windows 98™, Windows 2000™, Windows NT™, Windows ME™, Windows XP™, OS/2, Mac OS X, Unix, and Linux) and one or more application programs. Examples of application programs include authoring applications 276 (e.g., word processing, database programs, spreadsheet programs, and graphics programs) capable of generating documents or other electronic content; client applications 278 (e.g., America Online (AOL) client, CompuServe client, Instant Message (IM) client, AOL Television (TV) client, and ISP client) capable of communicating with other computer users, accessing various computer resources, and viewing, creating, or otherwise manipulating electronic content; and browser applications 280 (e.g., Netscape's Navigator and Microsoft's Internet Explorer) capable of rendering content such as standard Internet content and email content. Other examples of application programs may include, for example, a Point-to-Point Protocol (PPP) client, a User Datagram Protocol (UDP) client, a Point-to-Point Protocol over Ethernet (PPPoE) client, and a Layer Two Tunneling Protocol (L2TP) client, which may be included as a client application 278 or may be a separate application program used to support other application programs, such as the client applications 278 and the browser applications 280.

The general-purpose computer 270 also includes a central processing unit 282 (CPU) for executing instructions in response to commands from the personal computing controller 225. In one implementation, the CPU 282 executes instructions included in one or more of the application programs installed on the internal or external storage 272 of the general-purpose computer 270. In another implementation, the CPU 282 executes instructions included in application programs externally stored in and executed by one or more device(s) external to the general-purpose computer 270.

The general-purpose computer 270 typically will include a communication device 284 for sending and receiving data. One example of the communication device 284 is a modem, such as a DSL modem, a cable modem, or a satellite modem. Other examples include a transceiver, a set-top box, a communication card, a satellite dish, an antenna, or another network adapter capable of transmitting and receiving data over the communications link 215 through a wired or wireless data pathway 250. The general-purpose computer 270 also may include a TV tuner 286 for receiving TV programming in the form of broadcast, satellite, and/or cable TV signals. As a result, the personal computing device 220 can selectively and/or simultaneously display network content received by communications device 284 and television programming content received by the TV tuner 286.

The general-purpose computer 270 typically will include an input/output interface 288 to enable a wired or wireless connection to various peripheral devices 290. Examples of peripheral devices 290 include, but are not limited to, a mouse 291, a mobile phone 292, a personal digital assistant (PDA) 293, a keyboard 294, a display monitor 295 with or without a touch screen input, a TV remote control 296 for receiving information from and rendering information to subscribers, and/or an audiovisual input device 298. Other examples may include voice recognition and synthesis devices (not shown).

Although FIG. 2B illustrates devices, such as a mobile telephone 292, a PDA 293, and a TV remote control 296, as being peripheral with respect to the general-purpose computer 270, in another implementation, such devices may themselves include the functionality of the general-purpose computer 270 and operate as the personal computing device 220. For example, the mobile phone 292 or the PDA 293 may include computing and networking capabilities, and may function as a personal computing device 220 by accessing the delivery network 260 and communicating with the remote computing system 210. Furthermore, the local personal computing system 205 may include one, some or all of the components and devices described above, such as, for example, the personal computing device 220 may include a client device.

A browser application is an application that enables users to access and view electronic data content stored either locally or remotely, such as in a network environment (local area network (LAN), intranet, Internet). A typical browser application user interface window 300 provides a user with several options for specifying the particular content that the user desires to view. For example, the user can access a pull-down menu from a menu bar 302 to identify a particular file or address to open, or the user can manually type an address (e.g., Uniform Resource Locator (URL)) corresponding to the desired content in an Address field 304. A user may also select (e.g., by clicking with a mouse or otherwise selecting) a link 320 pointing to particular data content to access and view the data content.

A user may use a browser application running on the local system 105 to access, through the remote system 110, data content at a location identified by a URL. A URL does not necessarily specify a physical location. Rather, a data content that is identified by the URL can be stored in more that one physical location, and the data content can be retrieved from any one of the physical locations when requested by the user.

When a user specifies a data content location to access (e.g., by entering a URL in the address field 304 of the browser or by clicking on a hyperlink 330), the identified data content is fetched by the host system 110 and provided to the user's local system 105. A user may request data content from a location outside of the remote host system 110, in which case the host system 110 can retrieve the requested data content through a network connected to the host system (e.g., the Internet 112) and provide the data content to the user. The remote system 110 can cache a copy of the fetched data content on the remote system 11 0, so that if the data content is requested again by the user or by another user connected to the remote system 110, the data content can be fetched from the host system, rather than through the network. Fetching the data content from the remote system 110 is typically faster than fetching the data content through the network. Similarly, fetched data content can be cached on the local system 105, so that if the data content is requested a subsequent time it can be retrieved from within the local system 105 rather than through the network.

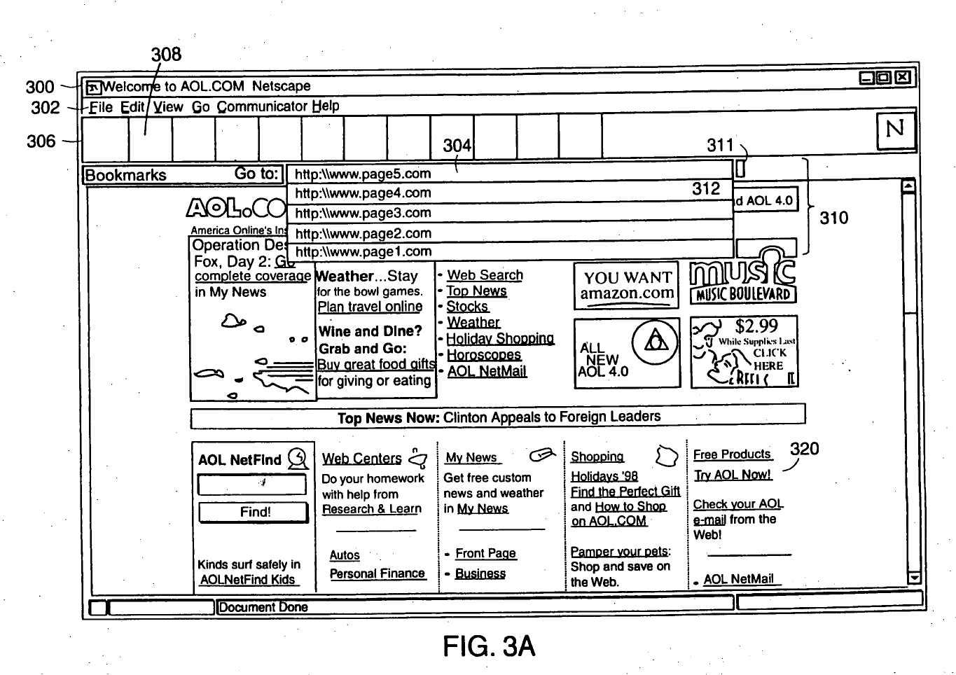

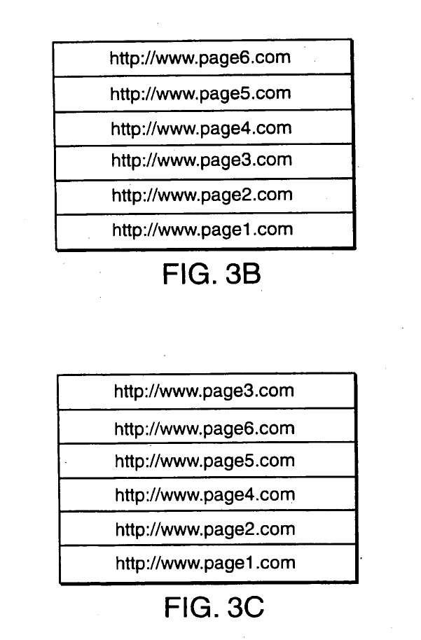

Several types of user applications maintain history state information identifying the programs, files or other content most recently accessed by the user. For instance, a word-processing program may maintain a history of recently accessed files that are accessible via a short drop-down menu showing three or four recently opened files, which enables a user to easily re-open a previously accessed file with a single click of the mouse button. Additionally, for example, the history of addresses or locations accessed by the user may therefore be tracked either by the browser 110 or by an application running on the remote system 110 through which the user accesses online data content. The history information typically includes the addresses of the data content accessed by the user along with the date and time the user accessed the content. More particularly, as a user accesses content at a particular address, moves to a new address, moves again to another new address, and so on, the browser application keeps track of the past files or addresses that the user has visited or otherwise accessed. If the user subsequently desires to return to one of these locations, the browser may provide several different mechanisms for doing so, for example as shown in FIG. 3A, through a drop-down window 310 referred to as a “history list”, and/or by using Back and Forward buttons 306 and 308, which provide stepwise access to the browser's “navigation tree”—a logical construct that defines the next location to jump to when either the Back 306 or Forward 308 buttons are clicked. The history list can store a list of addresses accessed by the user in the chronological order in which they were accessed.

In the example shown in FIG. 3A, a user presently accessing page5 can return to the immediately previous location, page4, either by clicking the cursor once on the Back button 306 or by clicking the cursor first on the combo-box button 311, which causes the history list 310 to be displayed, and then clicking the cursor on the second topmost entry 312 in the history list 310. The history list also shows that the user has previously accessed data content identified by page3, page2, and page1.

Whenever the browser accesses data content at another location, by whatever means, the history list 310 and the navigation tree may be updated or otherwise modified to reflect the current navigation state. For example, as shown in FIG. 3B, if a user jumps to a new location not yet visited (e.g., page6), the Address field 304 displays the new address, and the history list is modified by inserting a new entry 322 immediately below the Address field 304 to list the previous location (page5). When the list of addresses is stored in chronological order, the rest of the history entries 312-318 already in the history list 310 are shifted down by one row to make room for the new entry 322. If the history list 310 becomes too lengthy, the browser may delete the oldest entries to make room for each new location visited.

By way of another example, if the user then jumped to a previously visited location by clicking on an entry displayed in the history list 310, for example, page3, the browser would update the history list to appear as in FIG. 3C, in which the same entries appear but in a different order. Specifically, the updated history list 310 shown in FIG. 3C displays the now current address, page3, in the Address field 304, and the other previously visited locations are displayed below the Address field 304 in the order in which they were last visited (most recently visited at top, oldest at bottom). An entry for page3 no longer is displayed below the Address field 304 because the history list 310 typically will not contain duplicate entries for a location even though, as in this example, that location was visited more than once.

When the user does not know the location of the desired data content, the user may search for the data content among a multitude of different data content locations that are accessible to the user through the history list of the application being used to initiate the search, or the history list of other available and/or active applications.

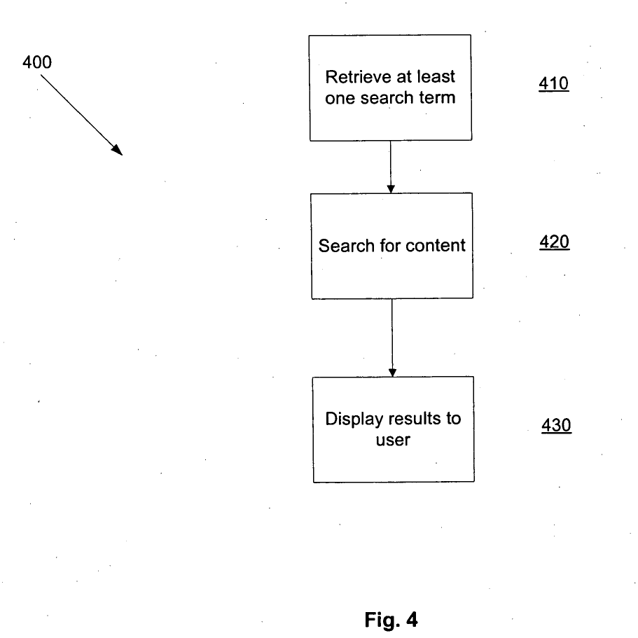

Referring to FIG. 4, an electronic search is performed according to a process 400. The search, which may be a search of the Internet 112, may be performed, for example, by the systems described above with respect to FIGS. 2A-2B. For instance, process 400 may be performed by the CPU 282 or the remote computing device 235. Process 400 also may be performed by any other hardware component or software component capable of being programmed to receive, process, and send instructions in the manner described.

Process 400 generally includes receiving a query from a user including at least one search term (step 410). Several search terms may be received (step 410) and may be grouped by default as a single string, or may be grouped in other ways. The search terms are typically received from a client system 105, 205 or from one or more components of the client system, as shown and described in FIGS. 2A-2B. Search terms generally include text defined by letters and/or numbers. However, search terms also may include other searchable content, such as symbols, other alphanumeric characters, and geometric constructs (e.g., arcs); Boolean operators (e.g., AND, OR, ADJ, NOT, NEAR) generally used to define relationships between search terms; parentheses and quotation marks generally used to indicate precision and to group search terms; wild card characters (e.g., ? and *) generally used to represent a portion of a search term; and concept operators (e.g., !) generally used to broaden the search term or phrase to a list of related words related to the search term or phrase in order to search using these related words.

The search term then is compared to data content from data content locations, such as, for example, the Internet 112 (step 420). The comparison step is generally performed automatically in response to the query. Comparing the received search term (step 420) may include using various algorithms, processes, and/or methods to perform the comparison to derive search results. For example, comparing the received search term (step 420) may include using a searching algorithm to search an index (e.g., an inverted index), an exact matching algorithm, keyword matching, other comparison algorithms, or any combination of these.

Finally, results that are based on identified matches are displayed to the user (step 430). Results of the search may include a list of data content locations containing data content in which the user might find the desired information. The results list may be ranked in order of anticipated relevance to the user.

However, because so many data content locations are searched for the desired content, the results of the search may be overly broad for the user. If the user narrows the scope of the search to limit the number of search results the desired data content may not be returned, again leading to an unsatisfying result for the user. Such problems in searching may be particularly frustrating to a user who has recently accessed and viewed the desired data content but cannot formulate a query to locate the desired content again. For example, a user may browse a website and see an advertisement for a $300 airfare from New York to Paris. Later, the user may want to locate this same website. However, an Internet-wide query for (“New York” AND PARIS AND $300) is likely to return too many result to be useful for the user.

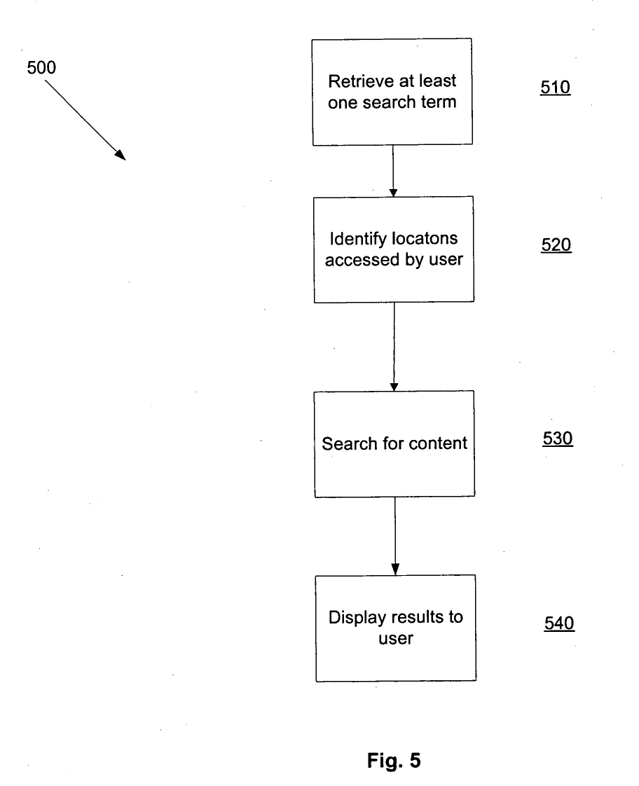

Thus, referring to FIG. 5, an electronic search for desired data content can be performed exclusive to, or with particular attention/disregard, for recently accessed data content locations according to a process 500. The search may be performed, for example, by the systems described above with respect to FIGS. 2A-2B. For instance, process 500 may be performed by the remote computing device 235. Process 500 also may be performed by any other hardware component or software component capable of being programmed to receive, process, and send instructions in the manner described.

Process 500 generally includes receiving a query from a user including at least one search term (step 510). Several search terms may be received (step 510) and may be grouped by default as a single string, or may be grouped in other ways. The search term(s) is/are typically received from a client system 105, 205 or from one or more components of the client system, as shown and described in FIGS. 2A-2B.

For the search term(s) to be compared to data content from a limited number of data content locations that have been previously accessed by a user, the limited number of data content locations are first identified (step 520). The data content locations can be identified, for example, from the user's history list. The history list can be stored on the remote system 110 or can be uploaded from the local system 105 to the remote system 110. The number of data content locations in which requested data is sought can be limited (e.g., automatically without user input, or at the discretion of the user, based on the user's input) to a subset of the data content locations in this history list. For example, the user may specify that the search should be performed only in data content locations that have been accessed within a specific time period. Moreover, the user may specify that a search should be performed against more than one specified content grouping, one of which being previously-accessed content locations. Still further, the user may request that search results be culled to filter, or organized to visually highlight, matches related to previously-accessed content locations.

After the limited number of data content locations has been identified (step 520), the search term(s) is/are compared to data content from the limited set of data content locations (step 530). The comparison step is generally performed automatically in response to the query. The comparison step may be performed against data content that has been cached on the local system 105 or on the remote system 110 or against data content in locations that are retrieved from the Internet or some other network.

Finally, results that are based on identified matches are displayed to the user (step 540). Results of the search may include a list of data content locations containing data content in which the user might find the desired information. The results list may be ranked in order of anticipated relevance to the user.

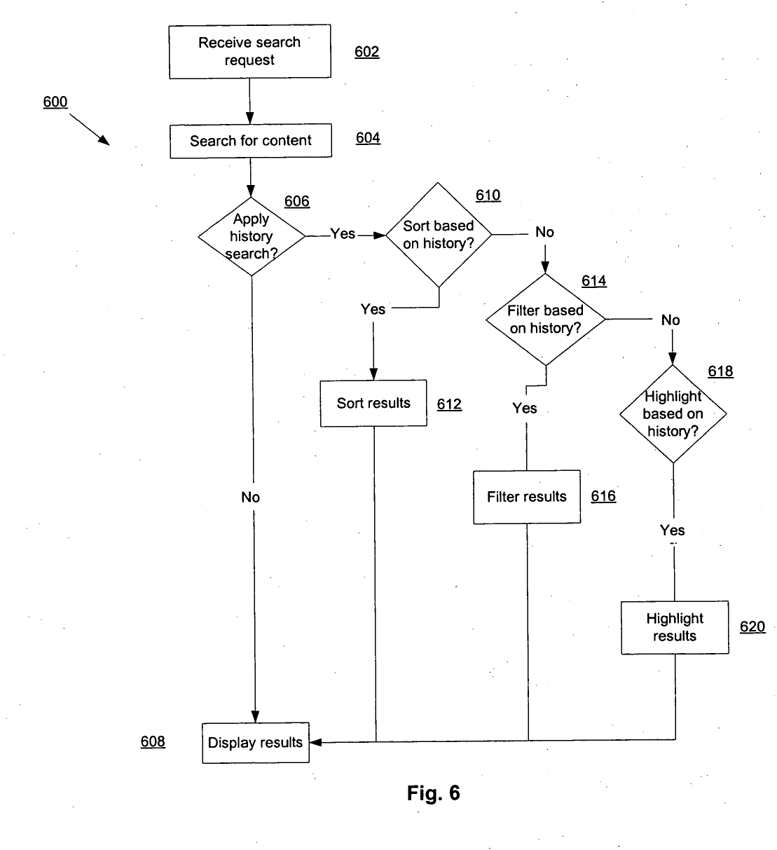

Referring to FIG. 6, a process 600 can display search results to a user in different formats, which can include history-based search results. In the process 600, a search query is received (step 602) and a search for data content is performed (step 604). If a history search is not specified (step 606), then the results of the search performed in step 604 are displayed to the user (step 608).

If a history search is specified (step 606), then the results of the search can be sorted based on the history of the user's online activity (step 612). For example, the application can compare the data content locations that are found as results of the search in step 604 with data content locations that have been accessed recently by the user. Based on the comparison, the application can display search results that match the recently accessed data content locations as the first search results listed for display to the user. After the sort is performed, the sorted results are displayed to the user (step 608).

The results from the search performed in step 604 can also be filtered based on the user's online activity (step 614). For example, the application can compare the data content locations that are found as results of the search in step 604 with data content locations that have been accessed recently by the user. Based on the comparison, the application can filter search results for display that correspond to recently accessed data content locations or the application can filter for display only those search results that correspond to online resources that the user has not previously accessed (step 614). Thus, search results corresponding to previously accessed online resources can be emphasized or de-emphasized. After the filtering step is performed, the filtered results are displayed to the user (step 608).

Individual results of the search performed in step 604 also (or alternatively) can be highlighted depending on whether they correspond to the online resources that the user has previously accessed (step 618). For example, search results that correspond to previously accessed online resources can be highlighted among the list of all search results displayed to the user (step 620). The highlighting of the particular results can include displaying the particular results in a distinctive font or color or adding additional marks to the results to indicate that the particular results correspond to an online resources that the user has previously accessed. After the highlighting of particular results is specified, the results are displayed to the user (step 608).

The described systems, methods, and techniques may be implemented in digital electronic circuitry, computer hardware, firmware, software, or in combinations of these elements. Apparatus embodying these techniques may include appropriate input and output devices, a computer processor, and a computer program product tangibly embodied in a machine-readable storage device for execution by a programmable processor. A process embodying these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

It will be understood that various modifications may be made without departing from the spirit and scope of the claims. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

1. A computer-implemented method of searching for particular data, the method comprising:
receiving a query from a user for particular online data content;
searching for the particular online data content at least within data content locations that have been previously accessed by the user;
presenting to the user search results satisfying the query; and
in the presentation of the search results, distinguishing search results corresponding to data content locations that have been accessed previously by the user from search results corresponding to data content location that have not been accessed previously by the user.

2. The method of claim 1, further comprising presenting to the user only search results corresponding to data content locations that have been accessed previously by the user.

3. The method of claim 1, wherein search results corresponding to data content locations that have been accessed previously by the user are distinguished from search results corresponding to data content locations that have not been accessed previously by the user by the order in which the search results are presented to the user.

4. The method of claim 1, wherein search results corresponding to data content locations that have been accessed previously by the user are distinguished from search results corresponding to data content locations that have not been accessed previously by the user by the visual presentation of the individual search results.

5. The method of claim 4, wherein the search results corresponding to data content locations that have been accessed previously by the user are presented to the user in a font that is different from a font in which search results corresponding to data content locations that have not been accessed previously by the user are presented to the user.

6. The method of claim 1, further comprising distinguishing, in the presentation of the search results, search results corresponding to data content locations that have been previously accessed by the user within a predetermined time period from search results that have not been previously accessed by the user.

7. The method of claim 6, wherein the predetermined time period ends at a time the search query was received from the user.

8. The method of claim 6, wherein the predetermined time period ends at a time before the search query was received from the user.

9. The method of claim 6, wherein the time period is specified by the user.

10. The method of claim 1, further comprising storing the identities of data content locations that have been previously accessed by the user.

11. The method of claim 10, wherein the identities are stored on a host computer system that communicates with a client computer system used by the user.

12. The method of claim 1, further comprising receiving a list of the identities of data content locations that have been previously accessed by the user from a client computer system used by the user.

13. The method of claim 1, further comprising storing data content from data content locations that have been previously accessed by the user.

14. The method of claim 13, wherein the stored data content is stored on a host computer system that communicates with a client computer system used by the user.

15. The method of claim 14, further comprising searching for the particular online data content within data content that is stored on the host computer.
